(19) United States
(12) Patent Application Publication
(10) Pub. No.: US 2021/0060667 A1
(43) Pub. Date: Mar. 4, 2021

(54) TOOL FOR BURR/FLASH REMOVAL

(71) Applicant: Jeffrey M. Watton, Chippewa Falls, WI (US)

(72) Inventor: Jeffrey M. Watton, Chippewa Falls, WI (US)

(21) Appl. No.: 16/873,942

(22) Filed: Aug. 20, 2020

Related U.S. Application Data
(60) Provisional application No. 62/892,639, filed on Aug. 28, 2019.

(51) Int. Cl. B23C 3/12; B23B 5/16

(52) U.S. Cl. CPC B23C 3/12; B23C 2220/16; B23B 5/16

(57) ABSTRACT

A tool for removing burrs/flash from a work piece includes a linear body having a cutter/abrasive end and an opposite shank end. The shank end is adapted for attachment to a rotary power source. At least one bushing is secured to the linear body, the bushing allowing rotation of the tool there within while an outer portion of the bushing remains stationary.

### CROSS-REFERENCE TO RELATED APPLICATIONS, IF ANY

This application claims the benefit under 35 U.S.C. § 119 (e) of co-pending provisional application Ser. No. 62/892,639, filed 28 Aug. 2019. Application Ser. No. 62/892,639 is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates to removal of burrs from items and, more particularly, to a tool for removal of burrs from metals or polymeric items, and most particularly to a tool for removal of burrs from metal castings or plastic molded items.

### 2. Background Information

In the manufacture of metal or plastic items, there is often a need to remove imperfections produced during the manufacturing process. In particular, the casting of metal or plastic items using molds, such as sand molds or metal molds, produces burrs on the surface of the molded item. Removal of the burrs requires the use of various hand held grinding or cutting tools. Care must be taken not to damage the cast item while removing the burrs. Some examples of tools used for removal of burrs from work pieces include the following.

Webster, in U.S. Pat. No. 573,744, describes a buffing or polishing device on a shaft that includes two collars on the shaft. A continuous linear wire or string is fastened between the collars on sets of pegs on each of the collars. Several layers of abrasive in sheets are mounted on the wire. Rotation of the device provides polishing or sanding of a surface. Note that the collars are rigidly mounted to the shaft.

In U.S. Pat. No. 6,179,532, Oldham discloses a flexible deburring tool 10 for removing burrs from a metal component made of unitary construction having a handle 11 and a tool head 13 with a flexible shaft 12 extending between them that allows the tool head to be positioned in hard to reach or tight fitting situations. The tool head 13 is provided with a recess to receive a tool bit 14 such as a deburring bit. The shaft 12 is narrower than the handle 11 and allows a range of flexation greater than 90 degrees. Note that the tool head 13 is rigidly attached to the shaft 12.

Prosel, in U.S. Pat. No. 6,254,467, describes a device for deburring work pieces, in particular molded parts and castings made of plastics, rubber or the like. The device comprising a rotatable shank (1) and linear tool elements (5, 6) which, in the axial direction, extend coaxially to the shank axis, are secured relative to the shank (1) and, as the latter rotates, can bulge out radially under the effect of centrifugal force. The device is designed such that an upper and a lower carrier (2, 3) are secured on the shank (1). The tool elements (5, 6) consist of individual threads or thread bundles whose ends are secured in the upper and lower carriers, a spring arrangement (7) being disposed concentrically with the shank (1) between the upper and lower carriers (2, 3).

In U.S. Pat. No. 7,056,201, Jespersen discloses a cylindric drum for a sanding/polishing tool, which in its drum surface is provided with a number of undercut axial grooves for mounting one or more axially displaceable sanding elements. An annular groove is provided either in the drum surface or a shaft perpendicularly to the rotational axis of the cylindric drum and along the periphery of either the surface of the drum or the surface of the shaft. A stop means has been arranged for accommodation in the annular groove in an axially fixed position, where at least a part of the stop means abuts on end faces of the moldings of the sanding elements mounted in the axial undercut grooves.

McDowell et al., in U.S. Pat. No. 9,138,868, describes a tool for removing material from a surface that includes a body 12 defining a longitudinal bore and an opening connecting an outer surface of the body to the longitudinal bore. A cutting element comprising a cutting surface is dimensioned to be at least partially received by the opening. The cutting surface is configured to translate from a first position to a second position in response to a centrifugal force. In the second position the cutting surface is extended outwardly through the opening, beyond the outer surface of the body. In one example, the tool may be used to remove material, such as oxidation, from the inner walls of a cylindrical article selected from a pipe and a tube.

Currently there are no hand tools available that can safely remove such burrs from castings or moldings and prevent inadvertent damage to the formed item itself. Thus, there is an unmet need for such a hand tool for this purpose. Applicant has invented such a hand tool for these tasks, a tool that is easy to operate and that prevents inadvertent damage to the casting or molded item.

### SUMMARY OF THE INVENTION

The invention is directed to a tool for removing burrs/flash from a work piece. The tool includes a cutter/abrasive section and at least one shank end. The at least one shank end is adapted for attachment to a rotary power source. The tool includes at least one bearing/bushing secured thereto, the bearing/bushing allowing rotation of the tool there within while the outer portion of the bearing/bushing remains stationary. Preferably, the tool includes more than one bearing/bushing, each bearing/bushing secured at various locations on the tool.

### BRIEF DESCRIPTION OF THE DRAWINGS

FIG. 1 is a perspective view of one embodiment of the burr/flash removal tool of the present invention.

FIG. 2 is a sectional view of the embodiment of the burr/flash removal tool of FIG. 1 along line A-A of FIG. 1 of the present invention.

FIG. 3 is a perspective view of a second embodiment of the burr/flash removal tool of the present invention.

FIG. 4 is a sectional view of the embodiment of the burr/flash removal tool of FIG. 3 along line B-B of FIG. 3 of the present invention.

FIG. 5 is a perspective view of a third embodiment of the burr/flash removal tool without bushings of the present invention.

FIG. 6 is a perspective view of the embodiment of FIG. 5 of the burr/flash removal tool with the bushings of the present invention.

FIG. 7 is a perspective side view of a fourth embodiment of the burr/flash removal tool of the present invention.

FIG. 8 is another perspective side view of the fourth embodiment of the burr/flash removal tool of the present invention.

### DESCRIPTION OF THE EMBODIMENTS

### Nomenclature

10 Burr/Flash Removal Tool
12 Linear Body
14 Cutter/Abrasive Section
16 Shank End
18 Cutting Edges
20 Bushing/Bearing
22 Bushing/Bearing Inner Portion
24 Bushing/Bearing Outer Portion

### Construction

The invention is a tool for removing burrs/flash from a work piece. The tool 10 comprises a linear body 12 including a cutter/abrasive section 14 and at least one shank end 16. The at least one shank end 16 is adapted for attachment to a rotary power source. At least one bearing/bushing 20 is secured to the linear body 12, the bearing/bushing 20 allowing rotation of the tool there within while the outer portion of the bearing/bushing 20 remains stationary. Preferably, the tool 10 includes two bearings/bushings 20 secured at selected locations on the tool 10.

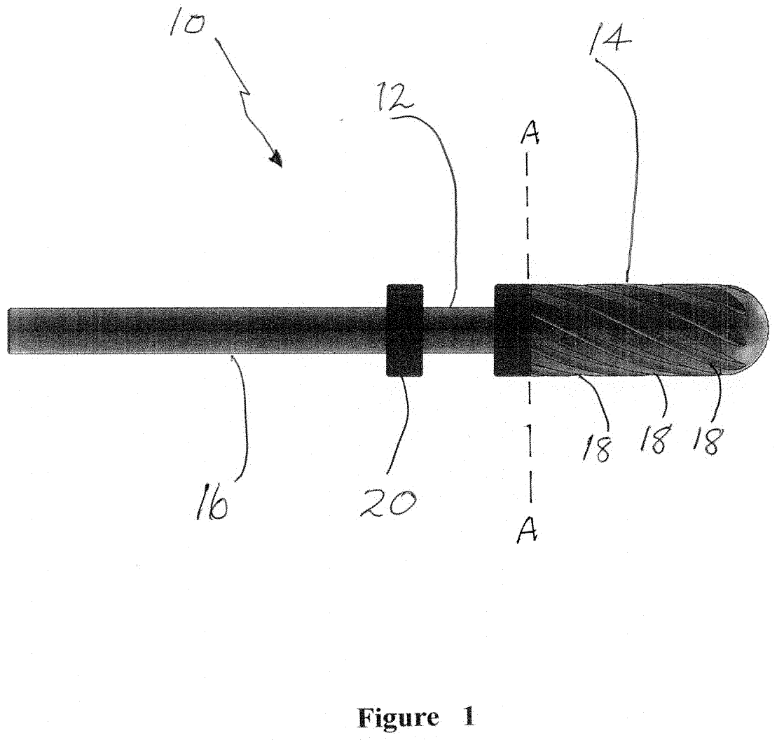

Referring now to FIG. 1, a first embodiment of the burr removing tool 10 is shown. The tool includes a linear body 12 with a cutter/abrasive end 14 and an opposite shank end 16. The shank end 16 is adapted for attachment to a rotary power source (not shown), such as a die grinder/power drill. The cutter/abrasive end 14 includes multiple cutting edges 18 which are used to remove flash/burrs and other imperfections on the surface of the work piece. At least one bearing/bushing 20 is secured to the linear body 12, allowing rotation of the linear body 12 there within, while the outer portion 24 of the bearing/bushing 20 is stationary. Thus, the operator can rest the bearing/bushing 20 on the work piece while the cutter/abrasive portion 14 of the tool 12 rotates to remove burrs/flash or other imperfections on the work piece. The ability of the operator to rest the bearing/bushing 20 or bearings/bushings 20 on the work piece greatly improves the control of the cutter/abrasive section 14 when removing flash/burrs or other imperfections.

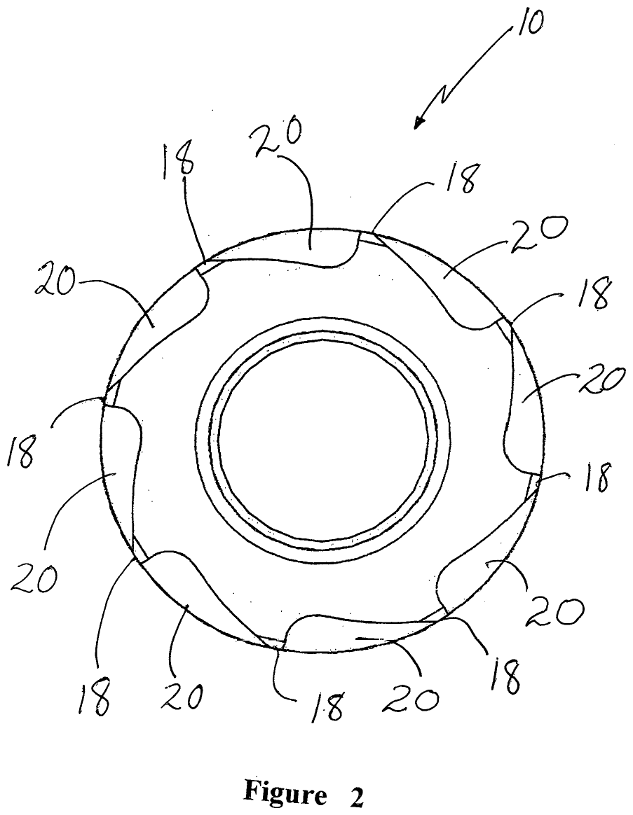

FIG. 2 provides a cross sectional view of the flash/burr removing tool 10 along line A-A of FIG. 1. Note the location of the multiple cutting edges 18.

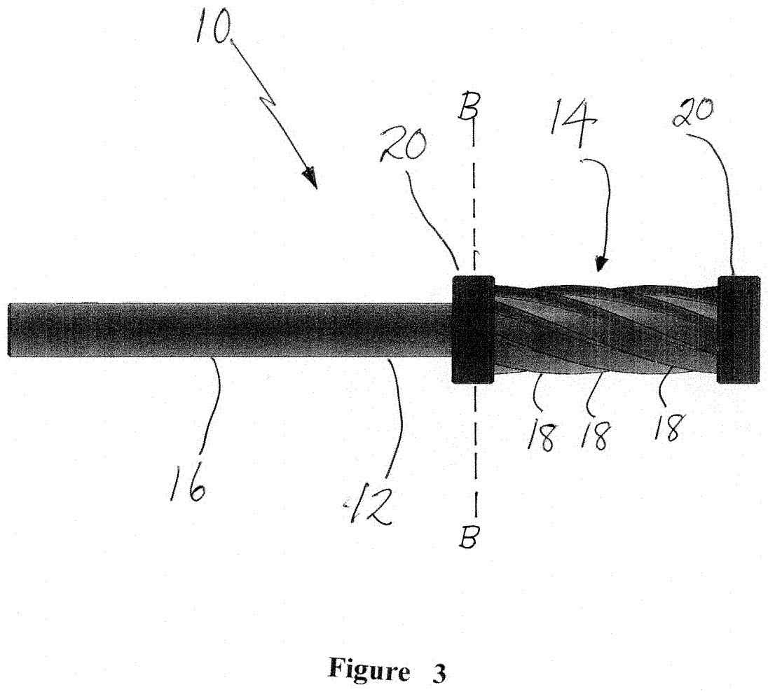

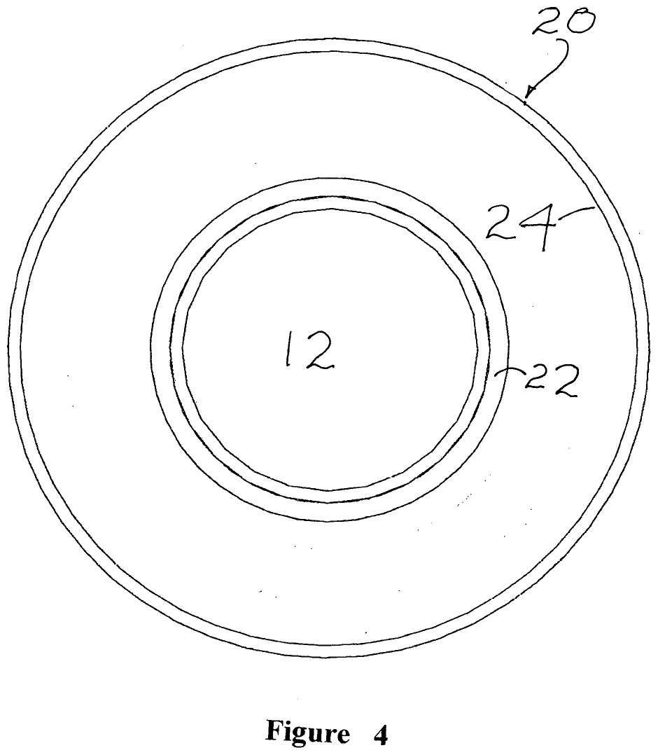

Referring now to FIG. 3, a second embodiment of the burr/flash removing tool 10 is shown. The tool 10 includes a linear body 12 with a cutter/abrasive end 14 and an opposite shank end 16. The shank end 16 is adapted for attachment to a rotary power source (not shown), such as a die grinder/power drill. The cutter/abrasive end 14 includes multiple cutting edges 18 which are used to remove burrs/flash and other imperfections on the surface of the work piece. At least one bearing/bushing 20 is secured to the linear body 10, allowing rotation of the tool 10 there within, while the outer portion 24 of the bearing/bushing 20 is stationary. In the embodiment of FIG. 3, the tool 10 includes two bearings/bushings 20, one bearing/bushing 10 at each end of the cutter/abrasive end 14 with the bearing/bushings 20 extending slightly beyond the cutter abrasive surface. FIG. 4 provides a cross sectional view of the tool along line B-B of FIG. 3.

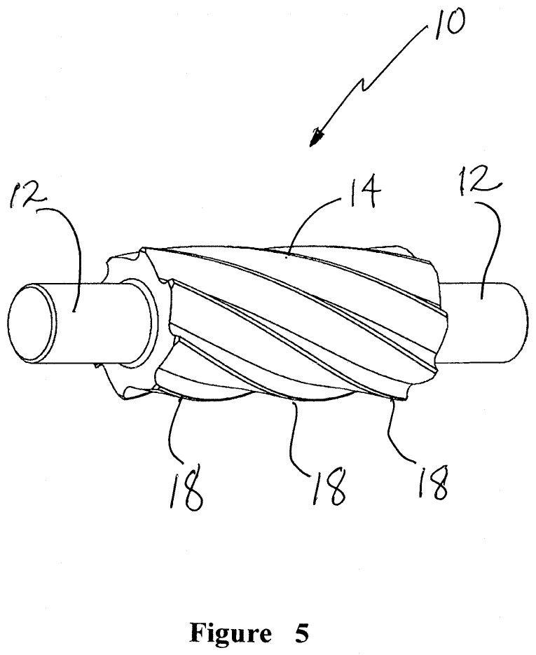

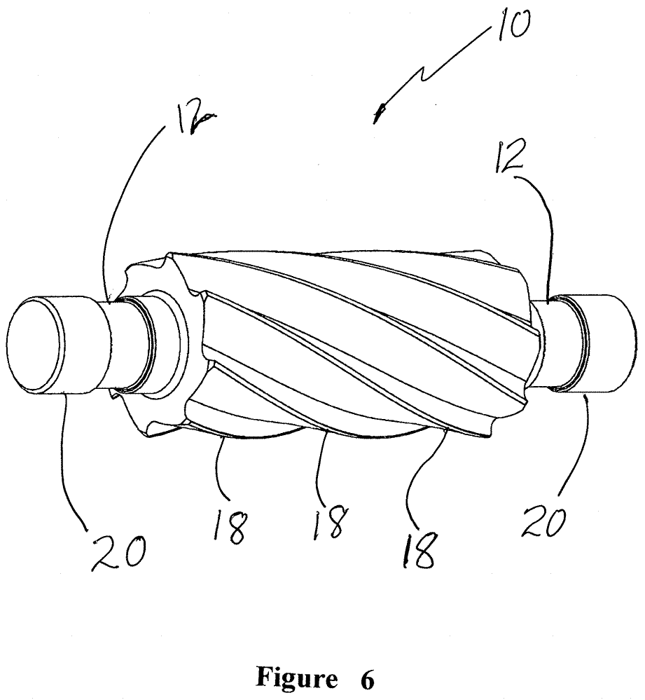

Referring now to FIG. 5, a third embodiment of the burr removal tool 10 is shown. The tool includes a linear body 12 with a cutter/abrasive section 14 and opposed shank ends 12, one at each end of the cutter/abrasive section 14. FIG. 6 shows the burr/flash removal tool 10 with multiple bearings/bushings 20 secured thereto. In this third embodiment, removal of one of the bearings/bushings 20 would be required to allow attachment of one shank end 12 to a rotary power source (not shown). The bushings will normally spin on the outside diameter while reducing friction and eliminating or reducing damage to the surface of the work piece.

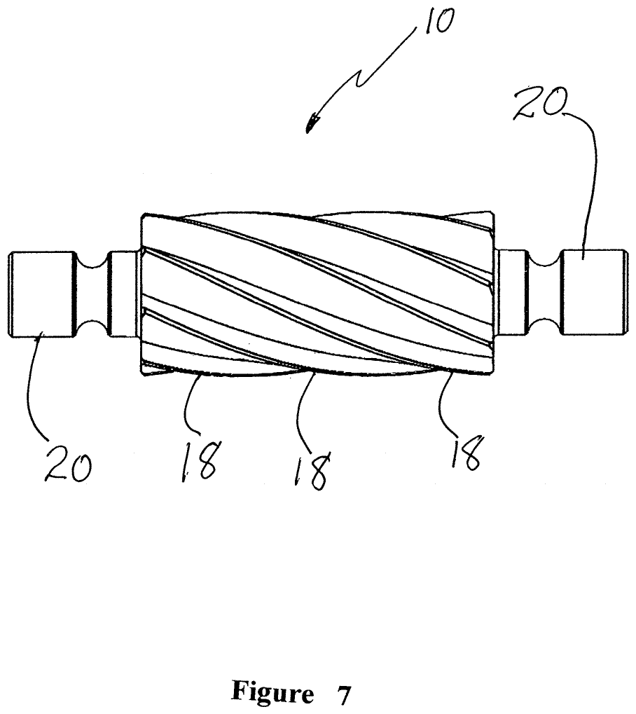

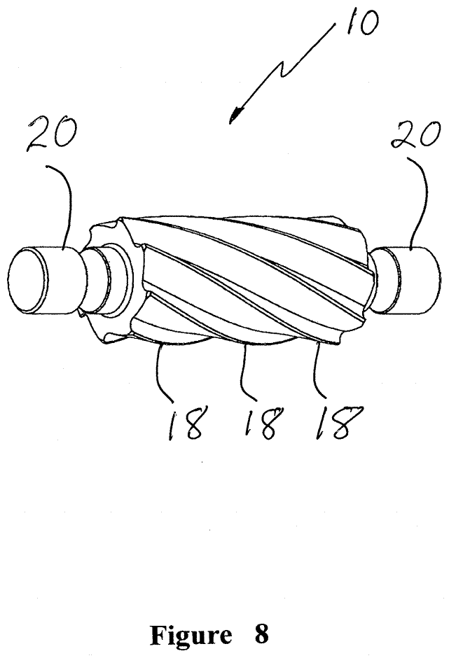

FIGS. 7 and 8 provide multiple perspective views of a similar burr/flash removal tool 10 with multiple bearing/bushings 20 secured thereto.

While the invention has been particularly shown and described with reference to preferred embodiments thereof, it will be understood by those skilled in the art that various changes in form and details may be made therein without departing from the spirit and scope of the invention.

I claim:

1. A tool for removing burrs/flash from a work piece comprising:
a linear body including a cutter/abrasive end and an opposite shank end, the shank end adapted for attachment to a rotary power source;
at least one bearing/bushing secured to the linear body, the bearing/bushing allowing rotation of the tool there within while an outer portion of the bearing/bushing remains stationary.

2. The tool according to claim 1 wherein the tool includes two bearings/bushings secured at selected locations on the tool.

3. The tool according to claim 2 wherein the two bearings/bushings are secured to the shank end of the linear body.

4. The tool according to claim 2 wherein a first bearing/bushing is secured adjacent a first end of the cutter/abrasive end thereof and a second bearing/bushing is secured adjacent a second end of the cutter/abrasive end thereof.
